(19) United States
(12) Patent Application Publication
(10) Pub. No.: US 2024/0126156 A1
(43) Pub. Date: Apr. 18, 2024

(54) LIGHT SOURCE DEVICE AND PROJECTOR

(71) Applicant: SEIKO EPSON CORPORATION, Tokyo (JP)

(72) Inventors: Yuichiro IWAMA, Azumino-shi (JP); Shigekazu AOKI, Matsumoto-shi (JP)

(21) Appl. No.: 18/485,580

(22) Filed: Oct. 12, 2023

(30) Foreign Application Priority Data
Oct. 13, 2022 (JP) 2022-164537

(51) Int. Cl. G03B 21/20; G03B 21/14

(52) U.S. Cl. CPC G03B 21/2066; G03B 21/145; G03B 21/204; G03B 21/208

(57) ABSTRACT

A light source device according to the present disclosure is provided with a light emitting element, a light guide member, a support member for supporting the light guide member in a groove part, and a holding member for holding the light guide member outside the groove part. The first face of the light guide member emits light guided by the light guide member, the light emitting element is disposed so as to be opposed to the third face, and the groove part has a support surface, a first wall surface, and a second wall surface. The light guide member has a protruding part which protrudes outside the groove part in at least one of both end portions on the first axis, and the protruding part is held by the holding member.

The present application is based on, and claims priority from JP Application Serial Number 2022-164537, filed Oct. 13, 2022, the disclosure of which is hereby incorporated by reference herein in its entirety.

### BACKGROUND

### 1. Technical Field

The present disclosure relates to a light source device and a projector.

### 2. Related Art

As a light source device used for a projector, there is proposed a light source device using fluorescence emitted from a phosphor when irradiating the phosphor with excitation light emitted from a light emitting element.

In International Patent Publication No. WO 2020/254455 (Document 1), there is disclosed a light source device provided with an excitation light source for emitting excitation light, a phosphor shaped like a rod for converting the excitation light into fluorescence, and a heat conduction member for releasing the heat generated in the phosphor. The phosphor is arranged inside a groove part of the heat conduction member.

In the light source device of this kind, it is conceivable that the excitation light emitted from the light emitting element spreads beyond the width of the phosphor to enter a gap between a wall surface of the groove part and the phosphor. However, in the light source device of Document 1, since the phosphor is arranged close to one of the wall surfaces of the groove part, the excitation light hardly enters the phosphor from the side surface at the side close to the wall surface. Therefore, the use efficiency of the excitation light becomes low, and there is a possibility that it is unachievable to obtain the fluorescence having a desired intensity.

Therefore, it is conceivable to arrange the phosphor so as to dispose gaps between the both side surfaces of the phosphor and the wall surfaces of the groove part in order to increase a light use efficiency of the excitation light. In this case, the positional accuracy in the groove part to the phosphor decreases to thereby decrease the incident efficiency of the excitation light to the phosphor, and thus, there is a possibility that it is unachievable to obtain the fluorescence having the desired intensity.

### SUMMARY

In view of the problems described above, the light source device according to an aspect of the present disclosure includes a light emitting element configured to emit light, a light guide member which the light emitted from the light emitting element enters, a support member which has a groove part, and which is configured to support the light guide member inside the groove part, and a holding member configured to hold the light guide member in an outside of the groove part of the support member, wherein the light guide member has a first face and a second face located at respective sides opposite to each other in a first axis along longitudinal of the light guide member, a third face and a fourth face located at respective sides opposite to each other in a second axis crossing the first axis, and a fifth face and a sixth face located at respective sides opposite to each other in a third axis crossing the first axis and the second axis, the first face of the light guide member emits light guided by the light guide member, the light emitting element is disposed so as to be opposed to the third face, the groove part has a support surface opposed to the fourth face, a first wall surface which is opposed to the fifth face and is separated from the fifth face, and a second wall surface which is opposed to the sixth face and is separated from the sixth face, and the light guide member has a protruding part which protrudes outside the groove part in at least one of both end portions on the first axis, the protruding part being held by the holding member.

A projector according to an aspect of the present disclosure includes the light source device according to the aspect of the present disclosure, a light modulation device configured to modulate the light emitted from the light source device in accordance with image information, and a projection optical device configured to project the light modulated by the light modulation device.

### BRIEF DESCRIPTION OF THE DRAWINGS

FIG. 1 is a diagram showing a schematic configuration of a projector according to an embodiment.

FIG. 2 is a schematic configuration diagram of a first illumination device.

FIG. 3 is a plan view of a light source device viewed from a Y-axis direction.

FIG. 4 is a cross-sectional view of the light source device along the line IV-IV shown in FIG. 3.

FIG. 5 is a cross-sectional view of the light source device along the line V-V shown in FIG. 3.

FIG. 6 is a diagram showing a problem of a light source device according to a comparative example.

FIG. 7 is a diagram showing another problem of the light source device according to the comparative example.

FIG. 8 is a plan view of a light source device according to a first modified example viewed from the Y-axis direction.

FIG. 9 is a plan view of a light source device according to a second modified example viewed from the Y-axis direction.

FIG. 10 is a plan view of a light source device according to a third modified example viewed from the Y-axis direction.

FIG. 11 is a plan view of a light source device according to a fourth modified example viewed from the Y-axis direction.

FIG. 12A is a cross-sectional view of a substantial part showing a configuration of a holding segment related to a modified example.

FIG. 12B is a diagram showing a configuration related to the modified example shown in FIG. 12A.

FIG. 12C is a cross-sectional view of a substantial part showing a configuration of a holding segment related to a modified example.

### DESCRIPTION OF AN EXEMPLARY EMBODIMENT

### First Embodiment

A first embodiment of the present disclosure will hereinafter be described.

A projector according to the present embodiment is an example of a projector using liquid crystal panels as light modulation devices.

In the drawings described below, constituents are shown with respective dimensional scale ratios different from each other in some cases in order to make the constituents eye-friendly.

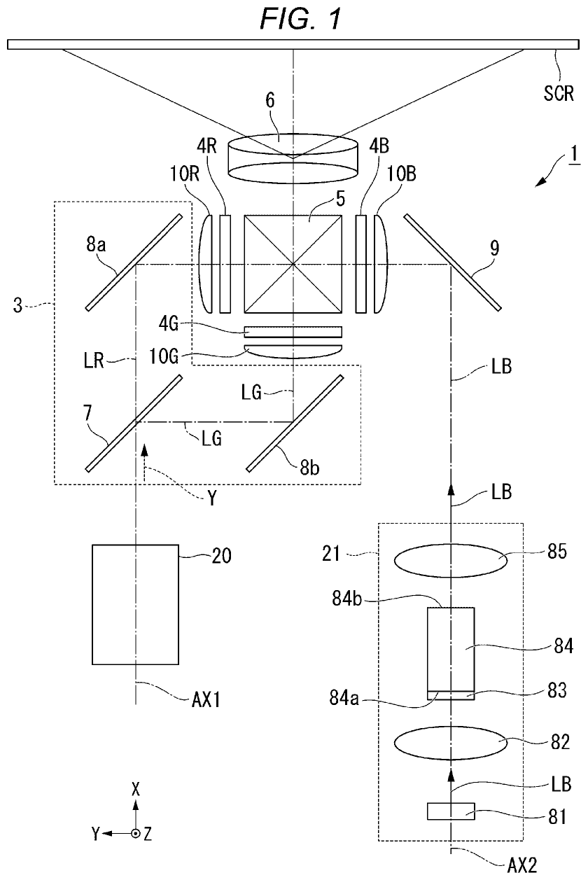

FIG. 1 is a diagram showing a schematic configuration of the projector 1 according to the present embodiment.

As shown in FIG. 1, the projector 1 according to the present embodiment is a projection-type image display device for displaying a color image on a screen SCR as a projection target surface. The projector 1 is provided with three light modulation devices corresponding to respective colored light, namely red light LR, green light LG, and blue light LB.

The projector 1 is provided with a first illumination device 20, a second illumination device 21, a color separation optical system 3, a light modulation device 4R, a light modulation device 4G, a light modulation device 4B, a light combining element 5, and a projection optical device 6.

The first illumination device 20 emits fluorescence Y having a yellow color toward the color separation optical system 3. The second illumination device 21 emits the blue light LB toward the light modulation device 4B. The detailed configurations of the first illumination device 20 and the second illumination device 21 will be described later.

Hereinafter, in the drawings, the explanation will be presented using an XYZ orthogonal coordinate system as needed. A Z axis is an axis extending along a vertical direction of the projector 1. An X axis is an axis parallel to an optical axis AX1 of the first illumination device 20 and an optical axis AX2 of the second illumination device 21. A Y axis is an axis perpendicular to the X axis and the Z axis. The optical axis AX1 of the first illumination device 20 is a central axis of the fluorescence Y emitted from the first illumination device 20. The optical axis AX2 of the second illumination device 21 is a central axis of the blue light LB emitted from the second illumination device 21. One of both directions along the X axis is referred to as a +X direction, the opposite direction thereto is referred to as a −X direction, one of both directions along the Y axis is referred to as a +Y direction, the opposite direction thereto is referred to as a −Y direction, one of both directions along the Z axis is referred to as a +Z direction, and the opposite direction thereto is referred to as a −Z direction. Further, the two directions along the X axis are referred to as X-axis directions when not distinguished from each other, the two directions along the Y axis are referred to as Y-axis directions when not distinguished from each other, and the two directions along the Z axis are referred to as Z-axis directions when not distinguished from each other.

The color separation optical system 3 separates the fluorescence Y having the yellow color emitted from the first illumination device 20 into the red light LR and the green light LG. The color separation optical system 3 is provided with a dichroic mirror 7, a first reflecting mirror 8a, and a second reflecting mirror 8b.

The dichroic mirror 7 separates the fluorescence Y into the red light LR and the green light LG. The dichroic mirror 7 transmits the red light LR, and at the same time, reflects the green light LG. The second reflecting mirror 8b is arranged in a light path of the green light LG. The second reflecting mirror 8b reflects the green light LG, which has been reflected by the dichroic mirror 7, toward the light modulation device 4G. The first reflecting mirror 8a is arranged in a light path of the red light LR. The first reflecting mirror 8a reflects the red light LR, which has been transmitted through the dichroic mirror 7, toward the light modulation device 4R.

Meanwhile, the blue light LB emitted from the second illumination device 21 is reflected by a reflecting mirror 9 toward the light modulation device 4B.

A configuration of the second illumination device 21 will hereinafter be described.

The second illumination device 21 is provided with a light source unit 81, a condenser lens 82, a diffuser plate 83, a rod lens 84, and a relay lens 85. The light source unit 81 is formed of at least one semiconductor laser. The light source unit 81 emits the blue light LB consisting of a laser beam. It should be noted that the light source unit 81 is not limited to the semiconductor laser, but can also be formed of an LED for emitting blue light.

The condenser lens 82 is formed of a convex lens. The condenser lens 82 makes the blue light LB emitted from the light source unit 81 enter the diffuser plate 83 in a state in which the blue light LB emitted from the light source unit 81 is substantially converged. The diffuser plate 83 diffuses the blue light LB emitted from the condenser lens 82 at a predetermined diffusion angle to generate the blue light LB having a substantially homogenous light distribution similarly to the fluorescence Y emitted from the first illumination device 20. As the diffuser plate 83, there is used, for example, obscured glass made of optical glass.

The blue light LB diffused by the diffuser plate 83 enters the rod lens 84. The rod lens 84 has a prismatic shape extending along a direction of the optical axis AX2 of the second illumination device 21. The rod lens 84 has an end plane of incidence of light 84a disposed at one end, and a light exit end surface 84b disposed at the other end. The diffuser plate 83 is fixed to the end plane of incidence of light 84a of the rod lens 84 via an optical adhesive (not shown). It is desirable to make the refractive index of the diffuser plate 83 and the refractive index of the rod lens 84 coincide with each other as precise as possible.

The blue light LB is emitted from the light exit end surface 84b in the state in which homogeneity of the illuminance distribution is enhanced by propagating through the rod lens 84 while being totally reflected. The blue light LB emitted from the rod lens 84 enters the relay lens 85. The relay lens 85 makes the blue light LB enhanced in homogeneity of the illuminance distribution by the rod lens 84 enter the reflecting mirror 9.

The shape of the light exit end surface 84b of the rod lens 84 is a rectangular shape substantially similar to a shape of an image formation area of the light modulation device 4B. Thus, the blue light LB emitted from the rod lens 84 efficiently enters the image formation area of the light modulation device 4B.

The light modulation device 4R modulates the red light LR in accordance with image information to form image light corresponding to the red light LR. The light modulation device 4G modulates the green light LG in accordance with the image information to form image light corresponding to the green light LG. The light modulation device 4B modulates the blue light LB in accordance with the image information to form image light corresponding to the blue light LB.

In each of the light modulation devices 4R, 4G, and 4B, there is used, for example, a transmissive liquid crystal panel. Further, on the incident side and the exit side of each of the liquid crystal panels, there are respectively disposed polarization plates (not shown). The polarization plate transmits only linearly-polarized light of a specific direction.

At the incident side of the light modulation device 4R, there is disposed a field lens 10R. At the incident side of the light modulation device 4G, there is disposed a field lens 10G. At the incident side of the light modulation device 4B, there is disposed a field lens 10B. The field lens 10R collimates a principal ray of the red light LR entering the light modulation device 4R. The field lens 10G collimates a principal ray of the green light LG entering the light modulation device 4G. The field lens 10B collimates a principal ray of the blue light LB entering the light modulation device 4B.

The light combining element 5 combines the image light corresponding respectively to the red light LR, the green light LG, and the blue light LB with each other in response to incidence of the image light respectively emitted from the light modulation device 4R, the light modulation device 4G, and the light modulation device 4B, and then emits the image light thus combined toward the projection optical device 6. As the light combining element 5, there is used, for example, a cross dichroic prism.

The projection optical device 6 is constituted by a plurality of projection lenses. The projection optical device 6 projects the image light combined by the light combining element 5 toward the screen SCR in an enlarged manner. Thus, a color image is displayed on the screen SCR.

Subsequently, a configuration of the first illumination device 20 will be described.

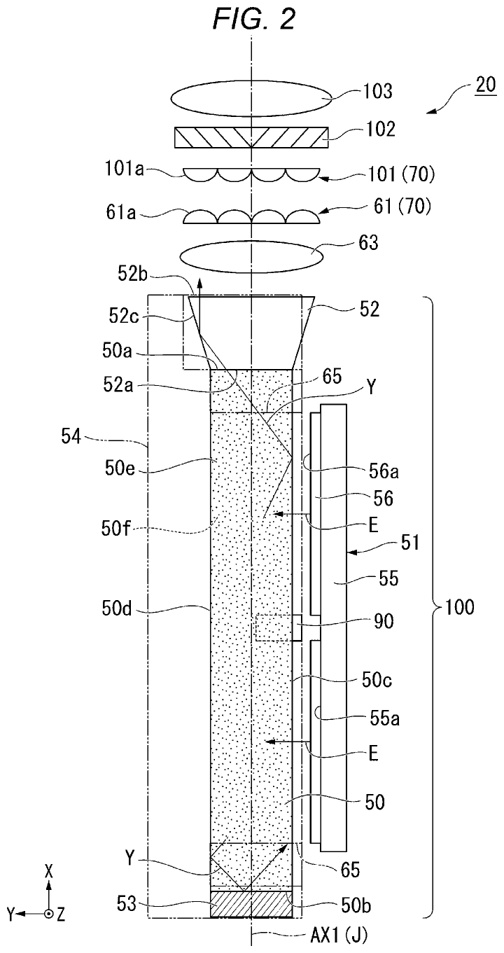

FIG. 2 is a schematic configuration diagram of the first illumination device 20.

As shown in FIG. 2, the first illumination device 20 is provided with a light source device 100, an integrator optical system 70, a polarization conversion element 102, and a superimposing optical system 103.

The light source device 100 is provided with a wavelength conversion member 50, a light source unit 51, an angle conversion member 52, a mirror 53, a support member 54, a holding member 65, and a pressing member 90. The wavelength conversion member 50 in the present embodiment corresponds to a light guide member in the appended claims.

The wavelength conversion member 50 has a quadrangular prismatic shape extending along the X axis, and has six faces. A side extending along the X axis of the wavelength conversion member 50 is longer than a side extending along the Y axis and a side extending along the Z axis. Therefore, the X axis corresponds to longitudinal of the wavelength conversion member 50. The length of the side extending along the Y axis and the length of a side extending along the Z axis are equal to each other. In other words, a cross-sectional shape of the wavelength conversion member 50 cut by a plane perpendicular to the X axis is a square. It should be noted that the cross-sectional shape of the wavelength conversion member 50 cut by the plane perpendicular to the X axis can be a rectangle.

The X axis in the present embodiment corresponds to a first axis in the appended claims. The Y axis in the present embodiment corresponds to a second axis in the appended claims. The Z axis in the present embodiment corresponds to a third axis in the appended claims.

The wavelength conversion member 50 has a first face 50a and a second face 50b, a third face 50c and a fourth face 50d, and a fifth face 50e and a sixth face 50f. The first face 50a and the second face 50b cross the X axis along the longitudinal of the wavelength conversion member 50, and are located at respective sides opposite to each other in the X axis. In the present embodiment, the first face 50a is located at the +X direction side as one of the X-axis directions, and the second face 50b is located at the −X direction side as the opposite one of the X-axis directions.

The third face 50c and the fourth face 50d cross the first face 50a and the second face 50b, and are located at respective sides opposite to each other in the Y axis crossing, perpendicular to, in the case of the present embodiment, the X axis along the longitudinal of the wavelength conversion member 50. In the present embodiment, the third face 50c is located at the −Y direction side as one of the Y-axis directions, and the fourth face 50d is located at the +Y direction side as the other of the Y-axis directions.

The fifth face 50e and the sixth face 50f cross the third face 50c and the fourth face 50d, and are located at respective sides opposite to each other in the Z axis crossing, perpendicular to, in the case of the present embodiment, the X axis and the Y axis. In the present embodiment, the fifth face 50e is located at the +Z direction side as one of the Z-axis directions, and the sixth face 50f is located at the −Z direction side as the other of the Z-axis directions.

In the following description, the third face 50c, the fourth face 50d, the fifth face 50e, and the sixth face 50f are referred to simply as side surfaces 50c, 50d, 50e, and 50f in some cases when not distinguished from each other.

The wavelength conversion member 50 includes at least a phosphor, and converts excitation light E having a first wavelength band emitted from the light emitting element 56 of the light source unit 51 into the fluorescence Y having a second wavelength band different from the first wavelength band. The excitation light E enters the wavelength conversion member 50 from the third face 50c. The fluorescence Y is guided inside the wavelength conversion member 50, and is then emitted from the first face 50a. The excitation light E in the present embodiment corresponds to first light in the appended claims. The fluorescence Y in the present embodiment corresponds to second light in the appended claims.

The wavelength conversion member 50 includes a ceramic phosphor made of a polycrystalline phosphor for wavelength-converting the excitation light E into the fluorescence Y. The second wavelength band provided to the fluorescence Y is a yellow wavelength band of, for example, 490 through 750 nm. In other words, the fluorescence Y is yellow fluorescence including a red light component and a green light component.

It is also possible for the wavelength conversion member 50 to include a single-crystal phosphor instead of the polycrystalline phosphor. Alternatively, the wavelength conversion member 50 can also be formed of fluorescent glass. Alternatively, the wavelength conversion member 50 can also be formed of a material obtained by dispersing a number of phosphor particles in a binder made of glass or resin. The wavelength conversion member 50 made of such a material converts the excitation light E into the fluorescence Y.

Specifically, the material of the wavelength conversion member 50 includes, for example, an yttrium aluminum garnet (YAG) phosphor. Citing YAG:Ce including cerium (Ce) as an activator agent as an example, as the material of the wavelength conversion member 50, there is used a material obtained by mixing raw powder including constituent elements such as Y₂O₃, Al₂O₃, and CeO₃ to cause the solid-phase reaction, Y—Al—O amorphous particles obtained by a wet process such as a coprecipitation process or a sol-gel process, and YAG particles obtained by a gas-phase process such as a spray drying process, a flame heat decomposition process, or a thermal plasma process.

The light source unit 51 is provided with a substrate 55 and light emitting elements 56. The light emitting elements 56 are each provided with a light emitting surface 56a for emitting the excitation light E in the first wavelength band. The light emitting elements 56 are each formed of, for example, a light emitting diode (LED). The light emitting surface 56a of the light emitting element 56 is opposed to the third face 50c of the wavelength conversion member 50, and emits the excitation light E toward the third face 50c. The first wavelength band is, for example, a wavelength band from a blue color to a violet color of 400 nm through 480 nm, and has a peak wavelength of, for example, 445 nm. As described above, the light source unit 51 is disposed so as to be opposed to the side surface 50c as one of the four side surfaces 50c, 50d, 50e, and 50f along the longitudinal direction of the wavelength conversion member 50.

The substrate 55 supports the light emitting elements 56. In the case of the present embodiment, a plurality of the light emitting elements 56 is disposed on one surface 55a of the substrate 55. The light source unit 51 is constituted by the light emitting elements 56 and the substrate 55 in the case of the present embodiment, but can also be provided with other optical members such as a light guide plate, a diffuser plate, or a lens besides the above. Further, although the plurality of light emitting elements 56 is used in the present embodiment, the number of the light emitting elements 56 is not particularly limited.

The support member 54 has a groove part 154 and supports the wavelength conversion member 50 inside the groove part 154, and at the same time, diffuses the heat generated in the wavelength conversion member 50 to release the heat to the outside. Therefore, it is desirable for the support member 54 to be formed of a material which has predetermined strength and is high in thermal conductivity. As the material of the support member 54, there is used metal such as aluminum or stainless steel, and in particular, an aluminum alloy such as 6061 aluminum alloy is preferably used. A specific configuration of the support member 54 will be described later.

The holding member 65 holds the wavelength conversion member 50 in the outside of the groove part 154 of the support member 54. Therefore, the wavelength conversion member 50 is set in the state in which the part of the wavelength conversion member 50 protrudes to the outside of the groove part 154 of the support member 54 without having contact with the wall surface of the groove part 154. The holding member 65 holds the portion protruding outside the groove part 154 in the wavelength conversion member 50. The holding member 65 limits a position of the wavelength conversion member 50 with respect to the support member 54 together with the pressing member 90. It should be noted that a specific configuration of the holding member 65 will be described later.

The mirror 53 is disposed on the second face 50b of the wavelength conversion member 50. The mirror 53 reflects the fluorescence Y which has been guided inside the wavelength conversion member 50, and has reached the second face 50b. The mirror 53 is formed of a metal film or a dielectric multilayer film formed on the second face 50b of the wavelength conversion member 50.

In the first illumination device 20, when the excitation light E emitted from the first light source unit 51 enters the wavelength conversion member 50, the phosphor included inside the wavelength conversion member 50 is excited, and the fluorescence Y is emitted from an arbitrary light emitting point. The fluorescence Y proceeds from the arbitrary light emitting point toward all directions, but the fluorescence Y having proceeded toward one of the four side surfaces 50c, 50d, 50e, and 50f proceeds toward the first face 50a or the second face 50b while repeating total reflection at a plurality of positions on the side surfaces 50c, 50d, 50e, and 50f. The first face 50a emits the fluorescence Y which has been guided in the wavelength conversion member 50 by being propagated due to the total reflection. In the case of the present embodiment, the fluorescence Y proceeding toward the first face 50a enters the angle conversion member 52 disposed on the first face 50a. The fluorescence Y having proceeded toward the second face 50b is reflected by the mirror 53, and then proceeds toward the first face 50a.

A part of the excitation light E which has not been used for the excitation of the phosphor out of the excitation light E having entered the wavelength conversion member 50 is reflected by a member on the periphery of the wavelength conversion member 50 including the light emitting element 56 of the light source unit 51, or the mirror 53 disposed on the second face 50b. Therefore, the part of the excitation light E is confined inside the wavelength conversion member 50 to be reused.

The angle conversion member 52 is disposed on the light exit side of the first face 50a of the wavelength conversion member 50. The angle conversion member 52 is formed of, for example, a taper rod. The angle conversion member 52 has a plane of incidence of light 52a which the fluorescence Y emitted from the wavelength conversion member 50 enters, a light exit surface 52b for emitting the fluorescence Y, and a side surface 52c for reflecting the fluorescence Y having entered the side surface 52c, toward the light exit surface 52b.

The angle conversion member 52 has a truncated quadrangular pyramid-like shape, and the area of a cross-section perpendicular to an optical axis J increases along the proceeding direction of the light. Therefore, the area of the light exit surface 52b is larger than the area of the plane of incidence of light 52a. An axis which passes through the center of the light exit surface 52b and the center of the plane of incidence of light 52a, and which is parallel to the X axis, is defined as the optical axis J of the angle conversion member 52. It should be noted that the optical axis J of the angle conversion member 52 coincides with the optical axis AX1 of the first illumination device 20.

The fluorescence Y having entered the angle conversion member 52 changes the direction so as to approximate to a direction parallel to the optical axis J every time the fluorescence Y is totally reflected by the side surface 52c while proceeding inside the angle conversion member 52. In such a manner, the angle conversion member 52 converts an exit angle distribution of the fluorescence Y emitted from the first face 50a of the wavelength conversion member 50. Specifically, the angle conversion member 52 makes a maximum exit angle of the fluorescence Y in the light exit surface 52b smaller than a maximum incident angle of the fluorescence Y in the plane of incidence of light 52a.

In general, since an etendue of light defined by a product of the area of a light exit region and a solid angle (a maximum exit angle) of the light is conserved, the etendue of the fluorescence Y is also conserved before and after the transmission through the angle conversion member 52. As described above, the angle conversion member 52 has the configuration in which the area of the light exit surface 52b is made larger than the area of the plane of incidence of light 52a. Therefore, in view of the conservation of the etendue, it is possible for the angle conversion member 52 to make a maximum exit angle of the fluorescence Y in the light exit surface 52b smaller than a maximum incident angle of the fluorescence Y in the plane of incidence of light 52a.

The angle conversion member 52 is fixed to the wavelength conversion member 50 via an optical adhesive (not shown) so that the plane of incidence of light 52a is opposed to the first face 50a of the wavelength conversion member 50. Specifically, the angle conversion member 52 and the wavelength conversion member 50 have contact with each other via the optical adhesive, and no air gap (no air layer) is disposed between the angle conversion member 52 and the wavelength conversion member 50. When an air gap is supposedly disposed between the angle conversion member 52 and the wavelength conversion member 50, the fluorescence Y having entered the plane of incidence of light 52a of the angle conversion member 52 at an angle no smaller than a critical angle out of the fluorescence Y having reached the plane of incidence of light 52a is totally reflected by the plane of incidence of light 52a, and fails to enter the angle conversion member 52. In contrast, when such an air gap is not disposed between the angle conversion member 52 and the wavelength conversion member 50 as in the present embodiment, it is possible to reduce the loss component of the fluorescence Y which fails to enter the angle conversion member 52 due to the total reflection. From this point of view, it is desirable to make the refractive index of the angle conversion member 52 and the refractive index of the wavelength conversion member 50 coincide with each other as precisely as possible.

It is also possible to use a compound parabolic concentrator (CPC) instead of the taper rod as the angle conversion member 52. Even when using the CPC as the angle conversion member 52, it is also possible to obtain substantially the same advantages as those when using the taper rod. It should be noted that the light source device 100 is not necessarily required to be provided with the angle conversion member 52.

A collimating optical system 63 formed of a collimator lens and so on is disposed between the light source device 100 and the integrator optical system 70. The collimating optical system 63 makes the angle distribution of the fluorescence Y emitted from the angle conversion member 52 smaller, and then makes the fluorescence Y high in parallelism enter the integrator optical system 70. It should be noted that the collimating optical system 63 is not required to be disposed when the parallelism of the fluorescence Y is sufficiently high.

The integrator optical system 70 has a first lens array 61 and a second lens array 101. The integrator optical system 70 functions as a homogenous illumination optical system for homogenizing an intensity distribution of the fluorescence Y emitted from the light source device 100 in each of the light modulation devices 4R, 4G as the illumination target areas in cooperation with the superimposing optical system 103. The fluorescence Y emitted from the collimating optical system 63 enters the first lens array 61. The first lens array 61 constitutes the integrator optical system 70 together with the second lens array 101 disposed in a posterior stage of the light source device 100.

The first lens array 61 has a plurality of first small lenses 61a. The plurality of first small lenses 61a is arranged in a matrix in a plane parallel to a Y-Z plane perpendicular to the optical axis AX1 of the first illumination device 20. The plurality of first small lenses 61a divides the fluorescence Y emitted from the angle conversion member 52 into a plurality of partial light beams. A shape of each of the first small lenses 61a is a rectangular shape substantially similar to a shape of each of the image formation areas of the light modulation devices 4R, 4G. Thus, each of partial light beams emitted from the first lens array 61 efficiently enters each of the image formation areas of the light modulation devices 4R, 4G.

The fluorescence Y emitted from the first lens array 61 proceeds toward the second lens array 101. The second lens array 101 is arranged so as to be opposed to the first lens array 61. The second lens array 101 has a plurality of second small lenses 101a corresponding to the plurality of first small lenses 61a of the first lens array 61. The second lens array 101 focuses an image of each of the first small lenses 61a of the first lens array 61 in the vicinity of each of the image formation areas of the light modulation devices 4R, 4G in cooperation with the superimposing optical system 103. The plurality of second small lenses 101a is arranged in a matrix in a plane parallel to the Y-Z plane perpendicular to the optical axis AX1 of the first illumination device 20.

Each of the first small lenses 61a of the first lens array 61 and each of the second small lenses 101a of the second lens array 101 have respective sizes the same as each other in the present embodiment, but can have respective sizes different from each other. Further, the first small lenses 61a of the first lens array 61 and the second small lenses 101a of the second lens array 101 are arranged at positions where respective optical axes coincide with each other in the present embodiment, but can be arranged in a state in which the axes are shifted from each other.

The polarization conversion element 102 converts the polarization direction of the fluorescence Y emitted from the second lens array 101. Specifically, the polarization conversion element 102 converts each of the partial light beams of the fluorescence Y which are divided by the first lens array 61, and which are emitted from the second lens array 101, into linearly polarized light.

The polarization conversion element 102 has a polarization splitting layer not shown for transmitting one of the linearly polarized components included in the fluorescence Y emitted from the light source device 100 without modification while reflecting the other of the linearly polarized components toward a direction perpendicular to the optical axis AX1, a reflecting layer not shown for reflecting the other of the linearly polarized components reflected by the polarization splitting layer, toward a direction parallel to the optical axis AX1, and a wave plate not shown for converting the other of the linearly polarized components reflected by the reflecting layer into the one of the linearly polarized components.

Characteristic points of the light source device 100 according to the present embodiment will hereinafter be described.

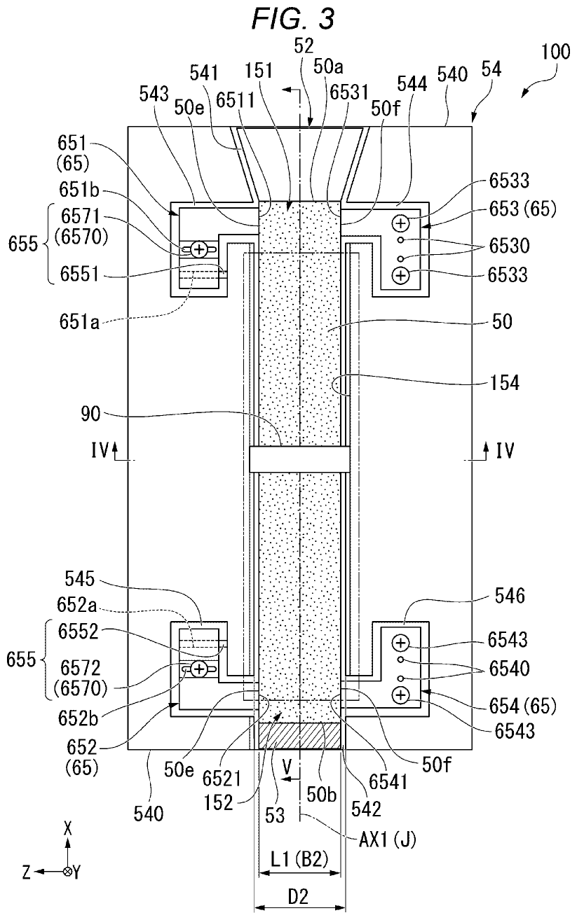

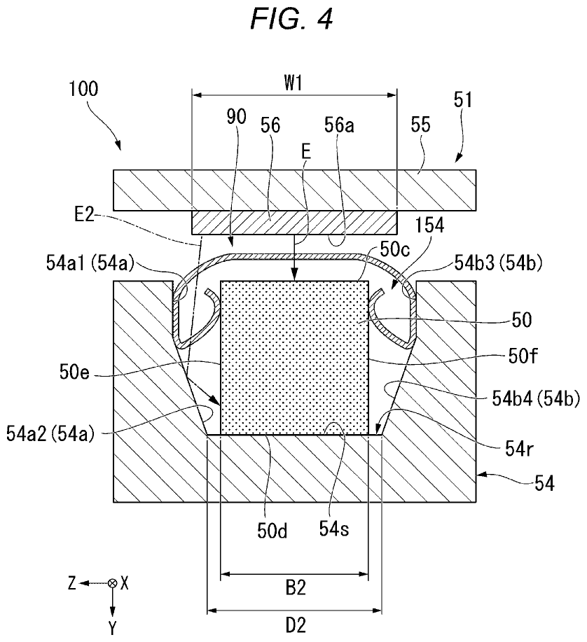

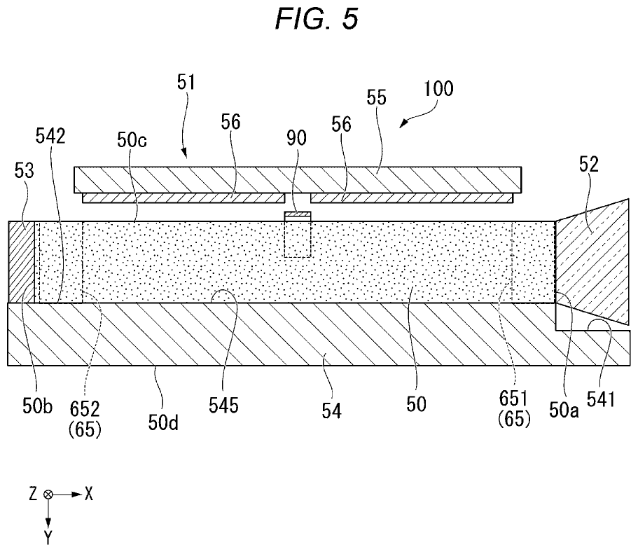

FIG. 3 is a plan view of the light source device 100 viewed from the Y-axis direction. FIG. 4 is a cross-sectional view of the light source device 100 along the line IV-IV shown in FIG. 3. FIG. 5 is a cross-sectional view of the light source device 100 along the line V-V shown in FIG. 3.

As shown in FIG. 3, the support member 54 is a plate-like member which has a groove part 154, a first housing part 541, a second housing part 542, a third housing part 543, a fourth housing part 544, a fifth housing part 545, and a sixth housing part 546, and which has a rectangular planar shape.

The groove part 154 extends in the X-axis direction along the longitudinal of the wavelength conversion member 50, and houses a part of the wavelength conversion member 50. In the case of the present embodiment, the wavelength conversion member 50 protrudes outside the groove part 154.

As shown in FIG. 4, a cross-section perpendicular to the X-axis direction of the groove part 154 of the support member 54 has a U-shape. The groove part 154 has a support surface 54s, a first wall surface 54a, and a second wall surface 54b.

The support surface 54s corresponds to a bottom surface of the groove part 154, and is opposed to the fourth face 50d of the wavelength conversion member 50. In the case of the present embodiment, the support surface 54s extends in parallel to the X-Z plane. The first wall surface 54a corresponds to one of side surfaces of the groove part 154, and is opposed to the fifth face 50e of the wavelength conversion member 50, and is separated from the fifth face 50e. The second wall surface 54b corresponds to the other of the side surfaces of the groove part 154, and is opposed to the sixth face 50f of the wavelength conversion member 50, and is separated from the sixth face 50f. In other words, a gap is disposed between the first wall surface 54a and the fifth face 50e of the wavelength conversion member 50. A gap is disposed between the second wall surface 54b and the sixth face 50f of the wavelength conversion member 50.

The first wall surface 54a has a first portion 54al located at the third face 50c side, and a second portion 54a2 located at the support surface 54s side. The first portion 54al extends in a direction perpendicular to the support surface 54s, namely in parallel to the X-Y plane. The second portion 54a2 is tilted so as to come closer to the fifth face 50e as proceeding from the first portion 54al toward the support surface 54s. In other words, a distance between the second portion 54a2 and the fifth face 50e at the support surface 54s side is shorter than a distance between the second portion 54a2 and the fifth face 50e at the first portion 54al side.

The second wall surface 54b has a third portion 54b3 located at the third face 50c side, and a fourth portion 54b4 located at the support surface 54s side. The third portion 54b3 extends in a direction perpendicular to the support surface 54s, namely in parallel to the X-Y plane. The fourth portion 54b4 is tilted so as to come closer to the sixth face 50f as proceeding from the third portion 54b3 toward the support surface 54s. In other words, a distance between the fourth portion 54b4 and the sixth face 50f at the support surface 54s side is shorter than a distance between the fourth portion 54b4 and the sixth face 50f at the third portion 54b3 side.

Each of the first wall surface 54a and the second wall surface 54b is formed of a surface of metal such as aluminum or stainless steel as the constituent material of the support member 54. More specifically, each of the first wall surface 54a and the second wall surface 54b is formed of a processed surface obtained by performing mirror finish on the metal surface described above. Therefore, each of the first wall surface 54a and the second wall surface 54b has light reflectivity, and reflects the excitation light E having entered the first wall surface 54a or the second wall surface 54b. It should be noted that each of the first wall surface 54a and the second wall surface 54b can be formed of another metal film or another dielectric multilayer film formed on a surface of metal such as aluminum or stainless steel.

A dimension W1 along the Z-axis direction of the light emitting surface 56a of the light emitting element 56 is larger than a width B2 along the Z-axis direction of the wavelength conversion member 50. It should be noted that the width in the Z-axis direction of the wavelength conversion member 50 in the present embodiment is equal throughout the whole length in the longitudinal direction.

Thus, in the Z-axis direction, both end portions of the light emitting surface 56a of the light emitting element 56 protrude outside the third face 50c of the wavelength conversion member 50. Specifically, the both end portions of the light emitting surface 56a of the light emitting element 56 protrude to positions where the end portions respectively overlap the gap between the fifth face 50e and the first wall surface 54a and the gap between the sixth face 50f and the second wall surface 54b. In other words, when viewing the light emitting surface 56a from the support surface 54s along the Y-axis direction, a part of the light emitting surface 56a overlaps the third face 50c, and another part of the light emitting surface 56a overlaps the gap between the fifth face 50e and the first wall surface 54a and the gap between the sixth face 50f and the second wall surface 54b.

A first width D2 along the Z-axis direction of the support surface 54s of the support member 54 is larger than the width B2 along the Z-axis direction of the wavelength conversion member 50. Thus, in the Z-axis direction, both end portions of the support surface 54s protrude outside the fourth face 50d of the wavelength conversion member 50. In other words, when viewing the support surface 54s from the light emitting surface 56a along the Y-axis direction, a part of the support surface 54s overlaps the fourth face 50d, and another part of the support surface 54s is exposed outside the fourth face 50d. As described above, the support surface 54s has an exposed part 54r exposed outside the wavelength conversion member 50.

As shown in FIG. 3 through FIG. 5, the pressing member 90 limits a position in the Z-axis direction of the wavelength conversion member 50 with respect to the support member 54 in the inside of the groove part 154.

The pressing member 90 is formed of an elastically-deformable material. As an example, the pressing member 90 is formed of a plate spring made of a metal material, and is formed of a stainless steel material such as SUS304. It should be noted that the pressing member 90 can be formed of a material such as resin or rubber providing the material is elastically deformable. It should be noted that it is desirable for the pressing member 90 to be formed of a material excellent in light resistance and heat resistance such as a metal material.

As shown in FIG. 3 and FIG. 5, when viewed from the Y-axis direction perpendicular to the third face 50c of the wavelength conversion member 50, the pressing member 90 is arranged at the position not overlapping the light emitting element 56 of the light source unit 51, and presses the wavelength conversion member 50 against the support surface 54s of the groove part 154 of the support member 54. The pressing member 90 is formed of a spring member such as a plate spring. In such a manner, a position in the Z-axis direction, namely a displacement in the Z-axis direction, with respect to the support member 54 of the wavelength conversion member 50 is limited by the pressing member 90.

In the case of the present embodiment, the pressing member 90 is arranged at a position not overlapping the light emitting element 56, and a central portion in the longitudinal direction of the wavelength conversion member 50. The pressing member 90 is not necessarily required to be arranged in the central portion of the wavelength conversion member 50. The pressing member is arranged at a position not overlapping the light emitting elements, and a position overlapping an area between the two light emitting elements when, for example, the three light emitting elements are arranged at intervals.

The wavelength conversion member 50 has a first protruding part 151 and a second protruding part 152 which protrude outside the groove part 154. The first protruding part 151 is a region protruding toward the +X direction from the groove part 154, and the second protruding part 152 is a region protruding toward the −X direction from the groove part 154. In the wavelength conversion member 50, the first protruding part 151 corresponds to the +X direction side of the wavelength conversion member 50, namely an end portion at the first face 50a side, and the second protruding part 152 corresponds to the −X direction side of the wavelength conversion member 50, namely an end portion at the second face 50b side. The wavelength conversion member 50 in the present embodiment has the first protruding part 151 at the first face 50a side in the X-axis direction, and the second protruding part 152 at the second face 50b side in the X-axis direction. In other words, the wavelength conversion member 50 in the present embodiment has the first protruding part 151 and the second protruding part 152 which protrude outside the groove part 154 in the both end portions on the X axis.

The first housing part 541 is a recessed part communicated with the +X direction side of the groove part 154. The first housing part 541 penetrates to an outer edge 540 of the support member 54. The first housing part 541 houses the first protruding part 151 of the wavelength conversion member 50 protruding from the groove part 154. The first housing part 541 houses the angle conversion member 52 fixed to the first face 50a of the wavelength conversion member 50. In the present embodiment, the angle conversion member 52 is disposed on the first face 50a of the first protruding part 151. The light exit surface 52b of the angle conversion member 52 housed in the first housing part 541 is coplanar with the outer edge 540 of the support member 54 in a plan view state.

The second housing part 542 is a recessed part communicated with the −X direction side of the groove part 154. The second housing part 542 penetrates to the outer edge 540 of the support member 54. The second housing part 542 houses the second protruding part 152 of the wavelength conversion member 50 protruding from the groove part 154. The second housing part 542 is disposed in the state of not communicated with the outer edge 540 of the support member 54. The second housing part 542 houses the second protruding part 152 of the wavelength conversion member 50 protruding from the groove part 154. In the present embodiment, the mirror 53 is disposed on the second face 50b of the second protruding part 152. The second housing part 542 houses the mirror 53 disposed on the second face 50b of the wavelength conversion member 50.

The third housing part 543 is a recessed part communicated with the +Z direction side of the first housing part 541. The third housing part 543 houses the holding member 65 for holding the first protruding part 151 of the wavelength conversion member 50 housed in the first housing part 541.

The fourth housing part 544 is a recessed part communicated with the −Z direction side of the first housing part 541. The fourth housing part 544 houses the holding member 65 for holding the first protruding part 151 of the wavelength conversion member 50 housed in the first housing part 541.

The fifth housing part 545 is a recessed part communicated with the +Z direction side of the second housing part 542. The fifth housing part 545 houses the holding member 65 for holding the second protruding part 152 of the wavelength conversion member 50 housed in the second housing part 542.

The sixth housing part 546 is a recessed part communicated with the −Z direction side of the third housing part 543. The sixth housing part 546 houses the holding member 65 for holding the second protruding part 152 of the wavelength conversion member 50 housed in the second housing part 542.

The holding member 65 holds the first protruding part 151 and the second protruding part 152 of the wavelength conversion member 50.

The holding member 65 has a pair of first holding segments 651, 652, a pair of holding segments 653, 654, and a positioning unit 655.

The first holding segment 651 as one of the pair of first holding segments has a first holding surface 6511 opposed to a part of the fifth face 50e corresponding to a surface at the +Z direction side of the first protruding part 151 of the wavelength conversion member 50. The first holding segment 651 is housed in the third housing part 543. The surface opposed to the first holding segment 651 in the first protruding part 151 corresponds to the fifth face 50e. Specifically, the fifth face 50e as the surface opposed to the first holding segment 651 in the first protruding part 151 extends along the X axis. In the case of the present embodiment, the surface opposed to the first holding segment 651 is a plane along the X axis. Therefore, since the first holding surface 6511 makes contact with the fifth face 50e as a plane in good condition, it is possible for the first holding segment 651 to easily and stably hold the surface at the +Z direction side of the first protruding part 151.

The first holding segment 652 as the other of the pair of first holding segments has a first holding surface 6521 opposed to a part of the fifth face 50e corresponding to a surface at the +Z direction side of the second protruding part 152 of the wavelength conversion member 50. The first holding segment 652 is housed in the fourth housing part 544. The surface opposed to the first holding segment 652 in the second protruding part 152 corresponds to the fifth face 50e. Specifically, the fifth face 50e as the surface opposed to the first holding segment 652 in the second protruding part 152 extends along the X axis. In the case of the present embodiment, the fifth face 50e opposed to the first holding segment 652 is a plane along the X axis. Therefore, since the first holding surface 6521 makes contact with the fifth face 50e as a plane in good condition, it is possible for the first holding segment 652 to easily and stably hold the surface at the +Z direction side of the second protruding part 152.

The second holding segment 653 as one of the pair of second holding segments has a second holding surface 6531 opposed to a part of the sixth face 50f corresponding to a surface at the −Z direction side of the first protruding part 151 of the wavelength conversion member 50. The second holding segment 653 is housed in the fifth housing part 545. By a pair of positioning pins 6530 being inserted into the second holding segment 653, the second holding segment 653 is arranged at a predetermined position in the fifth housing part 545. The second holding segment 653 is fixed to the support member 54 via screws 6533.

A surface opposed to the second holding segment 653 in the first protruding part 151 corresponds to the sixth face 50f. Specifically, the sixth face 50f as a surface opposed to the second holding segment 653 in the first protruding part 151 extends along the X axis. In the case of the present embodiment, the sixth face 50f as a surface opposed to the second holding segment 653 is a plane along the X axis. Therefore, since the second holding surface 6531 makes contact with the sixth face 50f as a plane in good condition, it is possible for the second holding segment 653 to easily and stably hold the surface at the −Z direction side of the first protruding part 151.

The second holding segment 654 as the other of the pair of second holding segments has a second holding surface 6541 opposed to a part of the sixth face 50f corresponding to a surface at the −Z direction side of the second protruding part 152 of the wavelength conversion member 50. The second holding segment 654 is housed in the sixth housing part 546. By a pair of positioning pins 6540 being inserted into the second holding segment 654, the second holding segment 654 is arranged at a predetermined position in the sixth housing part 546. The second holding segment 654 is fixed to the support member 54 via screws 6543.

A surface opposed to the second holding segment 654 in the second protruding part 152 corresponds to the sixth face 50f. Specifically, the sixth face 50f as a surface opposed to the second holding segment 654 in the second protruding part 152 extends along the X axis. In the case of the present embodiment, the surface opposed to the second holding segment 654 is a plane along the X axis. Therefore, since the second holding surface 6541 makes contact with the sixth face 50f as a plane in good condition, it is possible for the second holding segment 654 to easily and stably hold the surface at the −Z direction side of the second protruding part 152.

Here, a distance along the Z axis between the first holding surfaces 6511, 6521 of the first holding segments 651, 652 and the second holding surfaces 6531, 6541 of the second holding segments 653, 654 is defined as Li. As described above, a width along the Z axis of the support surface 54s of the groove part 154 is defined as a first width D2. Since the width in the Z-axis direction of the wavelength conversion member 50 in the present embodiment is equal throughout the whole length, a second width along the Z axis of the first protruding part 151 and the second protruding part 152 becomes B2. The width in the Z-axis direction of the first protruding part 151 and the second protruding part 152 is hereinafter referred to as the second width B2.

It is desirable to set the distance Li described above smaller than the first width D2, and equivalent to the second width B2, but it is conceivable when a variation occurs in the second width B2 due to, for example, a manufacturing error, and thus, the distance Li described above and the second width B2 fail to coincide with each other. In contrast, in the light source device 100 according to the present embodiment, it is possible to adjust the distance Li described above using the positioning unit 655 described later.

The positioning unit 655 includes a first rail 6551, a second rail 6552, and a plurality of screws 6570, and is capable of adjusting the positions in the Z-axis direction in the first holding segments 651, 652.

The first rail 6551 is a rail extending in the Z-axis direction, and holds the first holding segment 651 housed in the third housing part 543 so that the first holding segment 651 can move in the Z-axis direction. The first holding segment 651 has a rail groove 651a to be fitted to the first rail 6551.

The second rail 6552 is a rail extending in the Z-axis direction, and holds the first holding segment 652 housed in the fourth housing part 544 so that the first holding segment 652 can move in the Z-axis direction. The first holding segment 652 has a rail groove 652a to be fitted to the second rail 6552.

The plurality of screws 6570 includes a first screw 6571 for fixing the first holding segment 651 to the support member 54, and the second screw 6572 for fixing the first holding segment 652 to the support member 54.

The first screw 6571 is fastened to a threaded hole of the support member 54 via an elongated hole 651b extending in the Z-axis direction provided to the first holding segment 651. Therefore, by loosening the first screw 6571, the first holding segment 651 is made movable in the Z-axis direction along the first rail 6551, and by tightening the first screw 6571, the first holding segment 651 is inhibited from moving in the Z-axis direction.

The second screw 6572 is fastened to a threaded hole of the support member 54 via an elongated hole 652b extending in the Z-axis direction provided to the first holding segment 652. Therefore, by loosening the second screw 6572, the first holding segment 652 is made movable in the Z-axis direction along the second rail 6552, and by tightening the second screw 6572, the first holding segment 652 is inhibited from moving in the Z-axis direction.

Based on such a configuration, the positioning unit 655 is made possible to adjust the positions in the Z-axis direction in the first holding segments 651, 652. When the positions of the first holding segments 651, 652 change in the Z-axis direction, the positions of the first holding surface 6511 of the first holding segment 651 and the first holding surface 6521 of the first holding segment 652 change in the Z-axis direction. Thus, it is possible for the first holding surface 6511 of the first holding segment 651 to make contact with the fifth face 50e forming the first protruding part 151 of the wavelength conversion member 50 in good condition, and it is possible for the first holding surface 6521 of the first holding segment 652 to make contact with the fifth face 50e forming the second protruding part 152 of the wavelength conversion member 50 in good condition. In other words, it is possible to set the distance Li between the first holding surfaces 6511, 6521 of the first holding segments 651, 652 and the second holding surfaces 6531, 6541 of the second holding segments 653, 654 smaller than the first width D2 of the support surface 54s of the groove part 154, and equivalent to the second width B2 of the first protruding part 151 and the second protruding part 152.

Therefore, the first protruding part 151 is sandwiched between the first holding surface 6511 and the second holding surface 6531, and the second protruding part 152 is sandwiched between the first holding surface 6521 and the second holding surface 6541. In such a manner, it is possible for the holding member 65 in the present embodiment to hold the wavelength conversion member 50 in the groove part 154 in the state in which the movement in the Z-axis direction is restricted by holding the protruding part protruding outside the groove part 154 in the wavelength conversion member 50.

Here, a method of installing the wavelength conversion member 50 in the groove part 154 of the support member 54 will specifically be described.

First, the support member 54 in the state in which the holding member 65 is detached is prepared, and the wavelength conversion member 50 is installed inside the groove part 154. On this occasion, there is created the state in which the first protruding part 151 and the second protruding part 152 of the wavelength conversion member 50 protrude outside the groove part 154. It should be noted that the angle conversion member 52 and the mirror 53 can be fixed to the wavelength conversion member 50 in advance, or can also be fixed to the wavelength conversion member 50 after the installation into the groove part 154 is completed.

Subsequently, the second holding segment 653 is arranged in the fifth housing part 545 of the support member 54, the second holding segment 654 is arranged in the sixth housing part 546 of the support member 54, and the second holding segments 653, 654 are fixed with the screws 6533, 6543, respectively. By the second holding segments 653, 654 being arranged, the movement toward the −Z direction of the wavelength conversion member 50 in the first protruding part 151 and the second protruding part 152. Thus, there is created the state in which the sixth face 50f of the wavelength conversion member 50 is separated from the second wall surface 54b of the groove part 154.

Subsequently, the first holding segment 651 is arranged in the third housing part 543 of the support member 54, the first holding segment 652 is arranged in the fourth housing part 544 of the support member 54. Specifically, the rail groove 651a of the first holding segment 651 is set in the state of being fitted to the first rail 6551, and the first screw 6571 inserted through the elongated hole 651b is temporarily fixed to the threaded hole of the support member 54. Further, the rail groove 652a of the first holding segment 652 is set in the state of being fitted to the second rail 6552, and the second screw 6572 inserted through the elongated hole 652b is temporarily fixed to the threaded hole of the support member 54.

Then, the first holding segment 651 is slid along the first rail 6551 to thereby adjust the position in the Z-axis direction of the first holding segment 651, and make the first holding surface 6511 of the first holding segment 651 have contact with the fifth face 50e forming the first protruding part 151 of the wavelength conversion member 50. Similarly, the first holding segment 652 is slid along the second rail 6552 to thereby adjust the position in the Z-axis direction of the first holding segment 652, and make the first holding surface 6521 of the first holding segment 652 have contact with the fifth face 50e forming the second protruding part 152 of the wavelength conversion member 50. Lastly, the first screw 6571 and the second screw 6572 are tightened to fix the first holding segments 651, 652 to the support member 54, respectively. Thus, there is created the state in which the fifth face 50e of the wavelength conversion member 50 is separated from the first wall surface 54a of the groove part 154. Lastly, the wavelength conversion member 50 is pressed against the support member 54 via the pressing member 90.

In such a manner, the installation of the support member 54 into the groove part 154 in the wavelength conversion member 50 is completed.

### Advantages of First Embodiment

The light source device 100 according to the present embodiment is provided with the light emitting element 56 for emitting the excitation light E, the wavelength conversion member 50 which the excitation light E emitted from the light emitting element 56 enters, the support member 54 which has the groove part 154, and which supports the wavelength conversion member 50 inside the groove part 154, and the holding member 65 for holding the wavelength conversion member 50 in the outside of the groove part 154 of the support member 54. The wavelength conversion member 50 has the first face 50a and the second face 50b which are located at respective sides opposite to each other in the X axis along the longitudinal of the wavelength conversion member 50, the third face 50c and the fourth face 50d which are located at respective sides opposite to each other in the Y axis crossing the X axis, and the fifth face 50e and the sixth face 50f which are located at respective sides opposite to each other in the Z axis crossing the X axis and the Y axis. The first face 50a of the wavelength conversion member 50 emits the fluorescence Y guided by the wavelength conversion member 50, the light emitting element 56 is disposed so as to be opposed to the third face 50c, and the groove part 154 has the support surface 54s opposed to the fourth face 50d, the first wall surface 54a which is opposed to the fifth face 50e, and which is separated from the fifth face 50e, and the second wall surface 54b which is opposed to the sixth face 50f, and which is separated from the sixth face 50f. In the wavelength conversion member 50, the end portions at the first face 50a side and the second face 50b side in the X-axis direction respectively have the first protruding part 151 and the second protruding part 152 protruding outside the groove part 154. The first protruding part 151 and the second protruding part 152 are held by the holding member 65.

According to the light source device 100 related to the present embodiment, the first protruding part 151 and the second protruding part 152 of the wavelength conversion member 50 are held by the holding member 65 in the outside of the groove part 154 to thereby limit the position in the X-axis direction of the wavelength conversion member 50. Therefore, it is possible to accurately arrange the wavelength conversion member 50 inside the groove part 154. Therefore, the state in which the fifth face 50e of the wavelength conversion member 50 is separated from the first wall surface 54a of the groove part 154, and the sixth face 50f of the wavelength conversion member 50 is separated from the second wall surface 54b of the groove part 154 is stably maintained.

Therefore, the excitation light E emitted from the light emitting element 56 enters the wavelength conversion member 50 not only from the third face 50c, but also from the fifth face 50e and the sixth face 50f. As a result, it is possible to increase the use efficiency of the excitation light E compared to the related-art light source device in which the wavelength conversion member is arranged close to one of the wall surfaces of the groove part, and it is possible to obtain the fluorescence Y having the desired intensity.

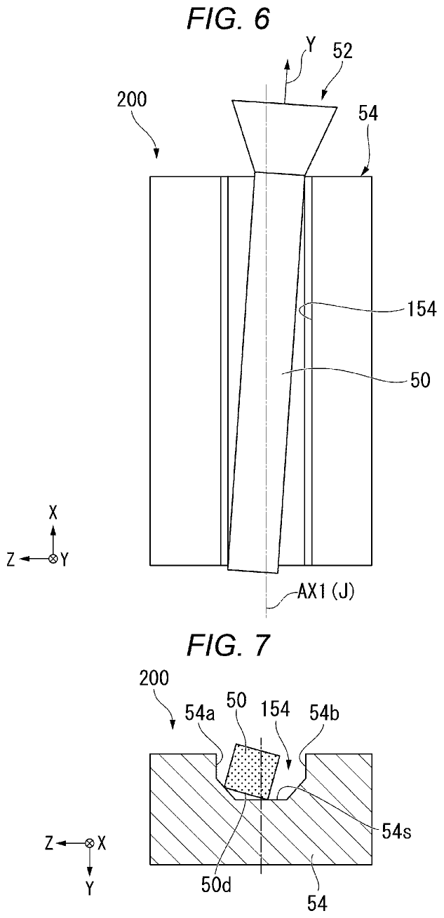

Even when the side surface of the wavelength conversion member 50 can be arranged in the state of being separated from the wall surface of the groove part 154, when it is assumed that the holding member 65 in the present embodiment does not exist, it is conceivable that the wavelength conversion member 50 is obliquely shifted with respect to the optical axis J in the inside of the groove part 154 of the support member 54 as shown in FIG. 6. In this case, the proceeding direction of the fluorescence Y emitted from the light source device 200 is shifted, and there occurs a problem that the fluorescence Y enters the optical system in the posterior stage of the light source device 200 at an angle larger than the assumed angle, a problem that the fluorescence Y fails to enter the optical system in the posterior stage of the light source device 200 in some cases, or the like. Alternatively, it is conceivable that a corner part of the wavelength conversion member 50 runs on the first wall surface 54a or the second wall surface 54b of the groove part 154 of the support member 54 as shown in FIG. 7. In this case, since the fourth face 50d of the wavelength conversion member 50 is separated from the support surface 54s of the support member 54, the heat of the wavelength conversion member 50 becomes to fail to sufficiently be transferred to the support member 54, and there is a possibility that the wavelength conversion efficiency decreases.

In view of these problems, according to the light source device 100 according to the present embodiment, since the position in the Z-axis direction of the wavelength conversion member 50 is limited by the holding member 65, the state in which the wavelength conversion member 50 is arranged at substantially the center in the Z-axis direction of the groove part 154 is maintained. Therefore, since the proceeding direction of the fluorescence Y emitted from the light source device 100 coincides with the optical axis J, it is possible to make the fluorescence Y having a desired incident angle and a desired light intensity enter the optical system in the posterior stage of the light source device 100. Further, it is inhibited that the corner part of the wavelength conversion member 50 runs on the first wall surface 54a or the second wall surface 54b of the groove part 154. Therefore, the heat of the wavelength conversion member 50 is sufficiently transferred to the support member 54, and thus, it is possible to maintain the desired wavelength conversion efficiency.

According to the light source device 100 related to the present embodiment, as shown in FIG. 4, excitation light E2 as a part of the excitation light E emitted from the light emitting surface 56a of the light emitting element 56 proceeds through the gap between the fifth face 50e of the wavelength conversion member 50 and the first portion 54al, and then enters the second portion 54a2 tilted with respect to the support surface 54s. On this occasion, the excitation light E2 is reflected by the second portion 54a2, and then enters the fifth face 50e of the wavelength conversion member 50. As described above, since it becomes easy for the excitation light E2 passing through the gap between the fifth face 50e of the wavelength conversion member 50 and the first wall surface 54a to enter the fifth face 50e, it is possible to reduce an amount of the excitation light E which is reflected by the support surface 54s to return to the light source unit 51 side. Further, a part of the excitation light E is reflected by the first portion 54al, and then enters the fifth face 50e of the wavelength conversion member 50. Thus, it is possible to realize the light source device 100 which is high in use efficiency of the excitation light E, and which is easy to obtain the fluorescence Y having the desired intensity.

The projector 1 according to the present embodiment is equipped with the light source device 100 according to the present embodiment, and is therefore excellent in light use efficiency.

### First Modified Example

A modified example of the present embodiment will hereinafter be described.

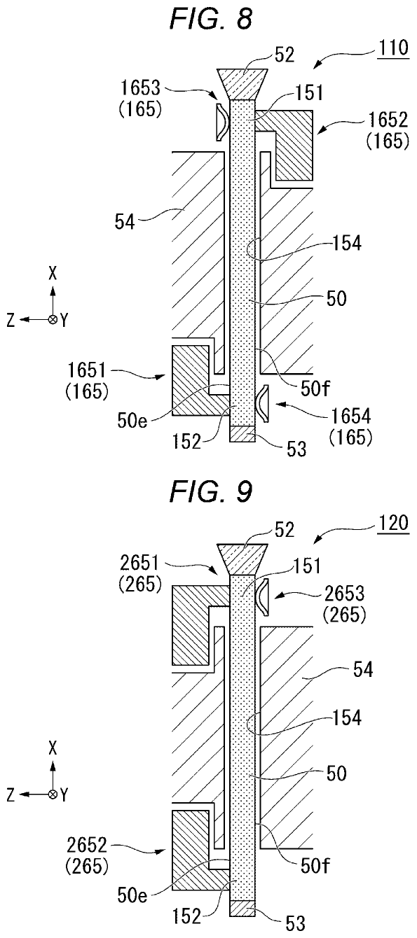

FIG. 8 is a plan view of a light source device 110 according to a first modified example viewed from the Y-axis direction. A difference between the present modified example and the embodiment described above is a configuration of the holding member. In each of the following drawings, the constituents common to the light source device 100 according to the embodiment described above are denoted by the same reference symbols, and the description thereof will be omitted.

As shown in FIG. 8, a holding member 165 in a light source device 110 according to the first modified example has a first holding segment 1651, a second holding segment 1652, a first spring member 1653, and a second spring member 1654.

The second holding segment 1652 holds a part of the sixth face 50f corresponding to a surface at the −Z direction side of the first protruding part 151 of the wavelength conversion member 50. The second holding segment 1652 is fixed to the support member 54 via screws not shown. The first spring member 1653 holds a part of the fifth face 50e corresponding to a surface at the +Z direction side of the first protruding part 151 of the wavelength conversion member 50. The first spring member 1653 is formed of, for example, a plate spring, and presses the sixth face 50f of the first protruding part 151 against the second holding segment 1652 with a pressing force of the spring. The first spring member 1653 can be displaced in the Z-axis direction, and can therefore make contact with the fifth face 50e of the first protruding part 151 without providing the positioning unit of the embodiment described above. As described above, by using the pressing force of the first spring member 1653, it is possible to hold the first protruding part 151 of the wavelength conversion member 50 in good condition.

The first holding segment 1651 holds a part of the fifth face 50e corresponding to a surface at the +Z direction side of the second protruding part 152 of the wavelength conversion member 50. The first holding segment 1651 is fixed to the support member 54 via screws not shown. The second spring member 1654 holds a part of the sixth face 50f corresponding to a surface at the −Z direction side of the second protruding part 152 of the wavelength conversion member 50. The second spring member 1654 is formed of, for example, a plate spring, and presses the fifth face 50e of the second protruding part 152 against the second holding segment 1652 with a pressing force of the spring. The second spring member 1654 can be displaced in the Z-axis direction, and can therefore make contact with the sixth face 50f of the second protruding part 152 without providing the positioning unit of the embodiment described above. As described above, by using the pressing force of the second spring member 1654, it is possible to hold the second protruding part 152 of the wavelength conversion member 50 in good condition.

It is possible for the holding member 165 in the present modified example to hold the first protruding part 151 of the wavelength conversion member 50 with the first spring member 1653 and the second holding segment 653, and hold the second protruding part 152 of the wavelength conversion member 50 with the second spring member 1654 and the first holding segment 652.

According to the holding member 165 in the present modified example, by using the pressing force of the spring member, it is possible to hold the first protruding part 151 and the second protruding part 152 of the wavelength conversion member 50 with the simpler configuration than in the embodiment described above.

It should be noted that since the holding member 165 in the present modified example has a configuration in which a gap is created on the periphery of a central portion in the longitudinal of the groove part 154, it is possible to limit the position in the Z-axis direction of the wavelength conversion member 50 with respect to the support member 54 in the inside of the groove part 154 by disposing the pressing member 90 of the embodiment described above.

Also in the light source device 110 according to the present modified example, since the use efficiency of the excitation light increases to ensure the desired wavelength conversion efficiency, it is possible to obtain substantially the same advantages as in the embodiment described above such as an advantage that it is possible to obtain the fluorescence having the desired intensity, and an advantage that it is possible to make the predetermined fluorescence enter the optical system in the posterior stage of the light source device 110.

It should be noted that in the holding member 165 in the present modified example, it is possible to omit either one of the first spring member 1653 and the second spring member 1654.

### Second Modified Example

FIG. 9 is a plan view of a light source device 120 according to a second modified example viewed from the Y-axis direction. A difference between the present modified example and the embodiment described above is a configuration of the holding member. In each of the following drawings, the constituents common to the light source device 100 according to the embodiment described above are denoted by the same reference symbols, and the description thereof will be omitted.

As shown in FIG. 9, a holding member 265 in the light source device 120 according to the second modified example has a pair of first holding segments 2651, 2652, and a spring member 2653.

The first holding segment 2651 holds a part of the fifth face 50e corresponding to the surface at the +Z direction side of the first protruding part 151 of the wavelength conversion member 50. The first holding segment 2651 is fixed to the support member 54 via screws not shown.

The first holding segment 2652 holds a part of the fifth face 50e corresponding to the surface at the +Z direction side of the second protruding part 152 of the wavelength conversion member 50. The first holding segment 2652 is fixed to the support member 54 via screws not shown.

The spring member 2653 presses a part of the sixth face 50f corresponding to the surface at the −Z direction side of the first protruding part 151 of the wavelength conversion member 50. The spring member 2653 is formed of, for example, a plate spring, and presses the fifth face 50e of the first protruding part 151 against the first holding segments 2651, 2652 with a pressing force of the spring. The spring member 2653 can be displaced in the Z-axis direction, and can therefore make contact with the sixth face 50f of the first protruding part 151 without providing the positioning unit of the embodiment described above.

The holding member 265 in the present modified example holds the first protruding part 151 of the wavelength conversion member 50 with the pressing force of the spring member 2653 and the first holding segment 2651, and holds the second protruding part 152 of the wavelength conversion member 50 with the pressing force of the spring member 2653 and the first holding segment 2652.

According to the holding member 265 in the present modified example, by using the pressing force of the spring member, it is possible to hold the first protruding part 151 and the second protruding part 152 of the wavelength conversion member 50 with the simple configuration. It should be noted that it is possible to change the position of the spring member 2653 to press a part of the sixth face 50f corresponding to the surface at the −Z direction side of the second protruding part 152 of the wavelength conversion member 50.

It should be noted that since the holding member 265 in the present modified example has a configuration in which a gap is created on the periphery of a central portion in the longitudinal of the groove part 154, it is possible to limit the position in the Z-axis direction of the wavelength conversion member 50 with respect to the support member 54 in the inside of the groove part 154 by disposing the pressing member 90 of the embodiment described above.

Also in the light source device 120 according to the present modified example, since the use efficiency of the excitation light increases to ensure the desired wavelength conversion efficiency, it is possible to obtain substantially the same advantages as in the embodiment described above such as an advantage that it is possible to obtain the fluorescence having the desired intensity, and an advantage that it is possible to make the predetermined fluorescence enter the optical system in the posterior stage of the light source device 120.

### Third Modified Example

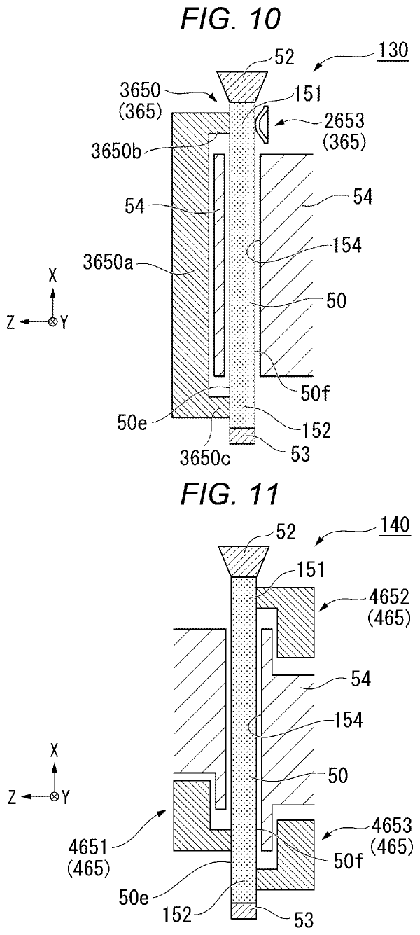

FIG. 10 is a plan view of a light source device 130 according to a third modified example viewed from the Y-axis direction. A difference between the present modified example and the second modified example is a configuration of the holding member. In each of the following drawings, the constituents common to the light source device 100 according to the embodiment described above are denoted by the same reference symbols, and the description thereof will be omitted.

As shown in FIG. 10, a holding member 365 in the light source device 130 according to the third modified example has a single holding segment 3650 and a spring member 2653. The holding segment 3650 in the present modified example is constituted by integrally forming the first holding segments 2651, 2652 of the second modified example. The holding segment 3650 of the present modified example has a main body part 3650a extending along the longitudinal of the wavelength conversion member 50, a first convex part 3650b which is disposed so as to protrude toward the −Z direction from the end portion at the +X direction side of the main body part 3650a, and which holds a part of the fifth face 50e of the first protruding part 151, and a second convex part 3650c which is disposed so as to protrude toward the −Z direction from the end portion at the −X direction side of the main body part 3650a, and which holds a part of the fifth face 50e of the second protruding part 152.

The holding member 365 in the present modified example holds the first protruding part 151 of the wavelength conversion member 50 with the pressing force of the spring member 2653 and the first convex part 3650b of the holding segment 3650, and holds the second protruding part 152 of the wavelength conversion member 50 with the pressing force of the spring member 2653 and the second convex part 3650c of the holding segment 3650.

According to the holding member 365 in the present modified example, by using the pressing force of the spring member 2653 and the holding segment 3650, it is possible to hold the first protruding part 151 and the second protruding part 152 of the wavelength conversion member 50 with the simple configuration. It should be noted that it is possible to change the position of the spring member 2653 to press a part of the sixth face 50f corresponding to the surface at the −Z direction side of the second protruding part 152 of the wavelength conversion member 50.

In the holding member 365 in the present modified example, since the first holding segments 2651, 2652 of the second modified example can be treated as an integrated member, an assembling work of the light source device 130 becomes easy.

Also in the light source device 130 according to the present modified example, since the use efficiency of the excitation light increases to ensure the desired wavelength conversion efficiency, it is possible to obtain substantially the same advantages as in the embodiment described above such as an advantage that it is possible to obtain the fluorescence having the desired intensity, and an advantage that it is possible to make the predetermined fluorescence enter the optical system in the posterior stage of the light source device 130.

### Fourth Modified Example

FIG. 11 is a plan view of a light source device 140 according to a fourth modified example viewed from the Y-axis direction. A difference between the present modified example and the embodiment described above is a configuration of the holding member. In each of the following drawings, the constituents common to the light source device 100 according to the embodiment described above are denoted by the same reference symbols, and the description thereof will be omitted.

As shown in FIG. 11, a holding member 465 in the light source device 140 according to the fourth modified example has a first holding segment 4651, and a pair of second holding segments 4652, 4653.

The first holding segment 4651 holds a part of the fifth face 50e corresponding to the surface at the +Z direction side of the second protruding part 152 of the wavelength conversion member 50. The first holding segment 4651 is fixed to the support member 54 via screws not shown so as to create a state of applying a predetermined pressing force to the fifth face 50e of the second protruding part 152.

The second holding segment 4652 as one of the second holding segments holds a part of the sixth face 50f corresponding to a surface at the −Z direction side of the first protruding part 151 of the wavelength conversion member 50. The second holding segment 4652 is fixed to the support member 54 via screws not shown so as to create a state of applying a predetermined pressing force to the sixth face 50f of the first protruding part 151.

The second holding segment 4653 as the other of the second holding segments holds a part of the sixth face 50f corresponding to a surface at the −Z direction side of the second protruding part 152 of the wavelength conversion member 50. The second holding segment 4653 is fixed to the support member 54 via screws not shown so as to create a state of applying a predetermined pressing force to the sixth face 50f of the second protruding part 152.

In the present modified example, a holding position of the fifth face 50e of the second protruding part 152 by the first holding segment 4651 and a holding position of the sixth face 50f of the second protruding part 152 by the second holding segment 4653 are shifted in the X-axis direction from each other. Specifically, the holding position by the first holding segment 4651 is located at the +X side of the holding position by the second holding segment 4653. In other words, the holding member 465 in the present modified example has a configuration of holding three places in the longitudinal direction of the wavelength conversion member 50.

It should be noted that since the holding member 465 in the present modified example has a configuration in which a gap is created on the periphery of a central portion in the longitudinal of the groove part 154, it is possible to limit the position in the Z-axis direction of the wavelength conversion member 50 with respect to the support member 54 in the inside of the groove part 154 by disposing the pressing member 90 of the embodiment described above.

According to the holding member 465 in the present modified example, by shifting the holding surfaces of the wavelength conversion member 50 to the three places in the longitudinal direction, it is possible to hold the first protruding part 151 and the second protruding part 152 of the wavelength conversion member 50 with a smaller number of holding segments than in the configuration of the embodiment described above, namely the three holding segments 4651, 4652, and 4653.

Also in the light source device 140 according to the present modified example, since the use efficiency of the excitation light increases to ensure the desired wavelength conversion efficiency, it is possible to obtain substantially the same advantages as in the embodiment described above such as an advantage that it is possible to obtain the fluorescence having the desired intensity, and an advantage that it is possible to make the predetermined fluorescence enter the optical system in the posterior stage of the light source device 140.

It should be noted that the scope of the present disclosure is not limited to the embodiment described above, and a variety of modifications can be provided thereto within the scope or the spirit of the present disclosure. Further, one aspect of the present disclosure can be provided with a configuration obtained by arbitrarily combining characterizing portions of the embodiment and the modified examples described above with each other.

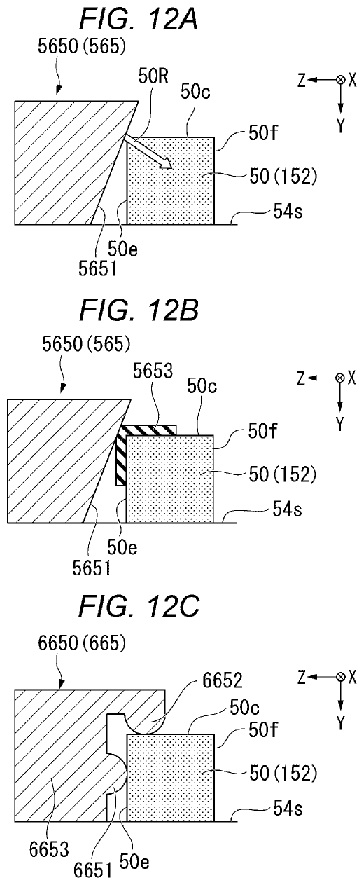

In the embodiment and the modified examples described above, there is cited when the holding segments having contact with the side surfaces of the first protruding part 151 and the second protruding part 152 of the wavelength conversion member 50 apply the force only in the Z-axis direction as an example, but the configuration of the holding segments is not limited thereto. As the holding segments, it is possible to adopt a configuration of applying a pressing force in the −X direction of pressing the wavelength conversion member 50 against the support surface 54s of the groove part 154 at the same time in addition to the pressing force in the Z-axis direction. A configuration of a holding segment capable of applying the pressing force in the Z-axis direction and in the −X direction described above will hereinafter be described with reference to FIG. 12A, FIG. 12B, and FIG. 12C. It should be noted that in FIG. 12A, FIG. 12B, and FIG. 12C, the holding segment for holding the fifth face 50e side of the second protruding part 152 of the wavelength conversion member 50 is cited as an example, but it is possible to apply the present disclosure to a holding segment for holding the sixth face 50f side of the second protruding part 152 and the first protruding part 151, or the spring member of the modified example described above.

A holding segment 5650 of a holding region 565 shown in FIG. 12A has a holding surface 5651 for holding a corner part 50R of the second protruding part 152 of the wavelength conversion member 50. It should be noted that the corner part 50R is a region where the fifth face 50e and the third face 50c cross each other. The holding surface 5651 of the holding segment 5650 presses the corner part 50R against the support surface 54s from an obliquely upside toward an obliquely downside, namely toward the −Z direction and the +Y direction. Therefore, the holding surface 5651 holds the second protruding part 152 in the −Z direction, and at the same time, generates a force for pressing the second protruding part 152 against the support surface 54s.

According to the holding segment 5650 having such a holding surface 5651, it is possible to hold the wavelength conversion member 50 in a more stable state.

It should be noted that when an external force or the like is applied, there is a possibility that the corner part 50R of the wavelength conversion member 50 and the holding surface 5651 are in friction to cause a chip in the corner part 50R. To cope with this, by disposing a cushion material 5653 between the holding surface 5651 and the corner part 50R as shown in FIG. 12B, it is possible to prevent the chip of the corner part 50R.

Further, a holding segment 6650 of a holding region 665 shown in FIG. 12C has a first contact part 6651, a second contact part 6652, and a main body part 6653. The main body part 6653 has a rectangular cross-sectional shape, and is formed integrally with the first contact part 6651 and the second contact part 6652. The first contact part 6651 extends from the main body part 6653 toward the −Z direction, and has a tip portion having contact with the fifth face 50e of the second protruding part 152 of the wavelength conversion member 50. The second contact part 6652 extends from the main body part 6653 toward the −Z direction, and then, a tip portion of the second contact part 6652 folded toward the −Y side makes contact with the third face 50c of the second protruding part 152 of the wavelength conversion member 50. It should be noted that the tip portions of the first contact part 6651 and the second contact part 6652 are each chamfered.

The holding segment 6650 holds the second protruding part 152 in the −Z direction with the first contact part 6651, and generates a force for pressing the second protruding part 152 against the support surface 54s with the second contact part 6652.

According to such a holding segment 6650, it is possible to hold the wavelength conversion member 50 in a more stable state. Further, since the holding segment does not make contact with the corner part 50R of the wavelength conversion member 50, it is possible to prevent the corner part 50R from chipping.

In the light source device 100 according to the embodiment described above, there is cited when the wavelength conversion member 50 has the protruding parts respectively at the first face 50a side and the second face 50b side in the X-axis direction as an example, but it is possible to dispose the protruding part at only either one of the first face 50a side and the second face 50b side in the X-axis direction. In this case, the holding member is arranged only at the side where the protruding part is disposed.

In the light source device 100 according to the embodiment described above, there is cited when the distance Li is set smaller than the first width D2 and equivalent to the second width B2 as an example, but it is possible to set the distance Li smaller than the first width D2 and larger than the second width B2. When setting the distance Li larger than the second width B2 as described above, since it is possible to provide a slight play between the holding member 65 and the wavelength conversion member 50, it is possible to prevent an occurrence of a problem such as a deformation or a breakage of the wavelength conversion member 50 due to stress applied to a contact portion between the holding member 65 and the wavelength conversion member 50. It should be noted that when the distance Li is smaller than the first width D2 of the support surface 54s of the groove part 154, there is no chance for the wavelength conversion member 50 and the wall surface of the groove part 154 to make contact with each other.

In the embodiment described above, each of the wall surfaces of the groove part of the support member has a portion perpendicular to the support surface and a portion tilted with respect to the support surface, but the shape of the groove part is not particularly limited, and for example, all of the areas of the wall surfaces of the groove part can be perpendicular to the support surface. Further, the wall surface of the groove part can be curved.

In the embodiment described above, there is cited when the angle conversion member 52 is separately disposed on the first face 50a as the light exit surface of the wavelength conversion member 50 as an example, but the angle conversion member 52 is not required to be disposed. In this case, it is possible to integrally form an exit part shaped like a truncated quadrangular pyramid having the cross-sectional area perpendicular to the optical axis increasing along the proceeding direction of the light at the light exit side of the wavelength conversion member.

In the embodiment described above, there is cited an example in which the present disclosure is applied to the light source device provided with the wavelength conversion member, but instead of this configuration, it is possible to apply the present disclosure to a light source device which propagates the incident light without the wavelength conversion, and then emits the incident light controlling, for example, the angular distribution. In that case, the wavelength conversion member of the embodiment described above is replaced with a light guide member, and the light emitted from the light emitting element is emitted from the angle conversion member as light in an unchanged wavelength band.

Besides the above, the specific descriptions of the shape, the number, the arrangement, the material, and so on of the constituents of the light source device and the projector are not limited to those in the embodiment described above, and can arbitrarily be modified. Further, although in the embodiment described above, there is described the example of installing the light source device according to the present disclosure in the projector using the liquid crystal panels, the example is not a limitation. The light source device according to the present disclosure can also be applied to a projector using digital micromirror devices as the light modulation devices. Further, the projector is not required to have a plurality of light modulation devices, and can be provided with just one light modulation device.

Although in the embodiment described above, there is described the example of applying the light source device according to the present disclosure to the projector, the example is not a limitation. The light source device according to the present disclosure can also be applied to lighting equipment, a headlight of a vehicle, and so on.

Hereinafter, the conclusion of the present disclosure will supplementarily be noted.

### Supplementary Note 1

A light source device including a light emitting element configured to emit light, a light guide member which the light emitted from the light emitting element enters, a support member which has a groove part, and which is configured to support the light guide member inside the groove part, and a holding member configured to hold the light guide member in an outside of the groove part of the support member, wherein the light guide member has a first face and a second face located at respective sides opposite to each other in a first axis along longitudinal of the light guide member, a third face and a fourth face located at respective sides opposite to each other in a second axis crossing the first axis, and a fifth face and a sixth face located at respective sides opposite to each other in a third axis crossing the first axis and the second axis, the first face of the light guide member emits light guided by the light guide member, the light emitting element is disposed so as to be opposed to the third face, the groove part has a support surface opposed to the fourth face, a first wall surface which is opposed to the fifth face and is separated from the fifth face, and a second wall surface which is opposed to the sixth face and is separated from the sixth face, and the light guide member has a protruding part which protrudes outside the groove part in at least one of both end portions on the first axis, the protruding part being held by the holding member.

According to the light source device having this configuration, since the protruding part of the light guide member is held by the holding member in the outside of the groove part, the position in the third axis direction of the light guide member is limited. Therefore, it is possible to accurately arrange the light guide member inside the groove part. Therefore, the state in which the fifth face of the light guide member is separated from the first wall surface of the groove part, and the sixth face of the light guide member is separated from the second wall surface of the groove part is stably maintained.

Therefore, the light emitted from the light emitting element enters the light guide member not only from the third face but also from the fifth face and the sixth face. As a result, it is possible to increase the use efficiency of the light compared to the related-art light source device in which the light guide member is arranged close to one wall surface of the groove part, and it is possible to obtain the light having the desired intensity.

### Supplementary Note 2

The light source device described in Supplementary Note 1, wherein the light guide member has a first protruding part including the first face, and an angle conversion member configured to convert an angle distribution of light emitted from the first face is disposed on the first face of the first protruding part.

According to this configuration, the vicinity of the first face of the first protruding part provided with the angle conversion member is held by the holding member. Therefore, it is possible to ease an impact by an external force or the like to the fixation part between the angle conversion member and the first face. Therefore, it is possible to increase the strength of the fixation part between the angle conversion member and the first face to provide the light source device excellent in impact resistance.

### Supplementary Note 3

The light source device described in Supplementary Note 2, wherein the light guide member has a second protruding part including the second face, and a mirror configured to reflect light guided in an inside of the light guide member is disposed on the second face of the second protruding part.

According to this configuration, the vicinity of the second face of the second protruding part provided with the mirror is held. Therefore, by holding both ends in the longitudinal direction of the light guide member, it is possible to reduce a vibration of the light guide member generated by the impact due to the external force or the like.

### Supplementary Note 4

The light source device described in any one of Supplementary Note 1 through Supplementary Note 3, wherein the holding member has a first holding segment configured to hold the fifth face side of the protruding part, and a second holding segment configured to hold the sixth face side of the protruding part.

According to this configuration, it is possible to hold the fifth face side and the sixth face side of the protruding part from the both sides. Therefore, it is possible to hold the light guide member in a direction along the third axis in good condition.

### Supplementary Note 5

The light source device described in Supplementary Note 4, wherein a distance along the third axis between a first holding surface of the first holding segment and a second holding surface of the second holding segment is smaller than a first width along the third axis of the support surface of the groove part, and equivalent to or larger than a second width along the third axis of the protruding part.

According to this configuration, the wavelength conversion member in which the protruding part is held by the first holding segment and the second holding segment becomes in a state in which the fifth face is separated from the first wall surface of the groove part, and the sixth face is separated from the second wall surface of the groove part. When the distance between the first holding surface and the second holding surface is equivalent to the second width, it is possible to fix the position in the third axis direction in the wavelength conversion member. Further, when the distance between the first holding surface and the second holding surface is larger than the second width, since it is possible to provide a slight play between the holding member and the light guide member, it is possible to prevent the deformation and the breakage of the light guide member caused by an application of the stress to a contact portion between the holding member and the light guide member.

### Supplementary Note 6

The light source device described in Supplementary Note 5, wherein the holding member further has a positioning unit configured to achieve an adjustment of a position in a direction along the third axis in at least one of the first holding segment and the second holding segment.

According to this configuration, it is possible to adjust the position in the third axis direction of at least one of the first holding segment and the second holding segment. Thus, it is possible to realize the configuration in which the distance between the first holding surface of the first holding segment and the second holding surface of the second holding segment is set smaller than the first width of the groove part and equivalent to or larger than the second width of the protruding part.

### Supplementary Note 7

The light source device described in any one of Supplementary Note 1 through Supplementary Note 6, wherein the first wall surface has a first portion located at the third face side, and a second portion located at the support surface side, the first portion extending in a direction perpendicular to the support surface, and the second portion tilting so as to come closer to the fifth face as proceeding from the first portion toward the support surface, the second wall surface has a third portion located at the third face side, and a fourth portion located at the support surface side, the third portion extending in the direction perpendicular to the support surface, and the fourth portion tilting so as to come closer to the sixth face as proceeding from the third portion toward the support surface, and the first portion, the second portion, the third portion, and the fourth portion reflect at least a part of the light emitted from the light emitting element.

According to this configuration, a part of the light emitted from the light emitting element proceeds through a gap between the fifth face of the light guide member and the first portion, and then enters the second portion tilted with respect to the support surface. On this occasion, the light is reflected by the second portion, and then enters the fifth face of the light guide member. As described above, since it becomes easy for the light passing through the gap between the fifth face of the light guide member and the first wall surface to enter the fifth face, it is possible to reduce an amount of the light which is reflected by the support surface and then returns to the light emitting element side. Further, a part of the light is reflected by the first portion extending perpendicularly to the support surface, and then enters the fifth face of the light guide member. Thus, it is possible to realize the light source device which is high in use efficiency of the light, and is easy to obtain the light having the desired intensity.

### Supplementary Note 8

The light source device described in any one of Supplementary Note 1 through Supplementary Note 7, wherein a surface opposed to the holding member in the protruding part extends along the first axis.

According to this configuration, when the holding surface of the protruding part with the holding member extends along the first axis, it is possible for the holding region to make contact with the protruding part in good condition compared to when the holding surface is tilted with respect to the first axis. Therefore, it is possible for the holding member to stably hold the protruding part.

### Supplementary Note 9

The light source device described in any one of Supplementary Note 1 through Supplementary Note 8, wherein the light emitting element is configured to emit first light having a first wavelength band, and the light guide member is a wavelength conversion member which includes a phosphor, and which is configured to convert the first light emitted from the light emitting element into second light having a second wavelength band different from the first wavelength band to emit the second light.

According to this configuration, it is possible to realize the light source device which is high in use efficiency of the first light, and obtains the second light having the desired intensity.

### Supplementary Note 10

A projector including the light source device described in any one of Supplementary Note 1 through Supplementary Note 9, a light modulation device configured to modulate the light emitted from the light source device in accordance with image information, and a projection optical device configured to project the light modulated by the light modulation device.

According to the projector having this configuration, since the light source device described above is provided, it is possible to provide the projector excellent in light use efficiency.

What is claimed is:

1. A light source device comprising:
a light emitting element configured to emit light;
a light guide member which the light emitted from the light emitting element enters;
a support member which has a groove part, and which is configured to support the light guide member inside the groove part; and
a holding member configured to hold the light guide member in an outside of the groove part of the support member, wherein
the light guide member has a first face and a second face located at respective sides opposite to each other in a first axis along longitudinal of the light guide member, a third face and a fourth face located at respective sides opposite to each other in a second axis crossing the first axis, and a fifth face and a sixth face located at respective sides opposite to each other in a third axis crossing the first axis and the second axis,
the first face of the light guide member emits light guided by the light guide member,
the light emitting element is disposed so as to be opposed to the third face,
the groove part has a support surface opposed to the fourth face, a first wall surface which is opposed to the fifth face and is separated from the fifth face, and a second wall surface which is opposed to the sixth face and is separated from the sixth face, and
the light guide member has a protruding part which protrudes outside the groove part in at least one of both end portions on the first axis, the protruding part being held by the holding member.

2. The light source device according to claim 1, wherein
the light guide member has a first protruding part including the first face, and
an angle conversion member configured to convert an angle distribution of light emitted from the first face is disposed on the first face of the first protruding part.

3. The light source device according to claim 2, wherein
the light guide member has a second protruding part including the second face, and
a mirror configured to reflect light guided in an inside of the light guide member is disposed on the second face of the second protruding part.

4. The light source device according to claim 1, wherein
the holding member has a first holding segment configured to hold the fifth face side of the protruding part, and a second holding segment configured to hold the sixth face side of the protruding part.

5. The light source device according to claim 4, wherein
a distance along the third axis between a first holding surface of the first holding segment and a second holding surface of the second holding segment is smaller than a first width along the third axis of the support surface of the groove part, and equivalent to or larger than a second width along the third axis of the protruding part.

6. The light source device according to claim 5, wherein
the holding member further has a positioning unit configured to achieve an adjustment of a position in a direction along the third axis in at least one of the first holding segment and the second holding segment.

7. The light source device according to claim 1, wherein
the first wall surface has a first portion located at the third face side, and a second portion located at the support surface side, the first portion extending in a direction perpendicular to the support surface, and the second portion tilting so as to come closer to the fifth face as proceeding from the first portion toward the support surface,
the second wall surface has a third portion located at the third face side, and a fourth portion located at the support surface side, the third portion extending in the direction perpendicular to the support surface, and the fourth portion tilting so as to come closer to the sixth face as proceeding from the third portion toward the support surface, and
the first portion, the second portion, the third portion, and the fourth portion reflect at least a part of the light emitted from the light emitting element.

8. The light source device according to claim 1, wherein
a surface opposed to the holding member in the protruding part extends along the first axis.

9. The light source device according to claim 1, wherein
the light emitting element is configured to emit first light having a first wavelength band, and
the light guide member is a wavelength conversion member which includes a phosphor, and which is configured to convert the first light emitted from the light emitting element into second light having a second wavelength band different from the first wavelength band to emit the second light.

10. A projector comprising:
the light source device according to claim 1;
a light modulation device configured to modulate the light emitted from the light source device in accordance with image information; and
a projection optical device configured to project the light modulated by the light modulation device.
